(19) United States
(12) Patent Application Publication
(10) Pub. No.: US 2013/0183097 A1
(43) Pub. Date: Jul. 18, 2013

(54) MODULAR SUBTERRANEAN IRRIGATION SYSTEM AND METHOD OF INSTALLATION

(71) Applicant: Wayne L. Scantling, Orlando, FL (US)

(72) Inventor: Wayne L. Scantling, Orlando, FL (US)

(21) Appl. No.: 13/351,441

(22) Filed: Jan. 17, 2012

(51) Int. Cl. A01G 25/06

(52) U.S. Cl. 405/43

(57) ABSTRACT

A modular subterranean irrigation system for providing water to the roots of landscape articles includes one or more water delivery modules each having a plurality interconnected hollow tubular elements configured to receive and transport water, and a plurality of openings for discharging the water to an outside environment. The system further includes at least one water source connector configured to connect the water delivery module to a water source.

### TECHNICAL FIELD

The present invention relates generally to irrigation devices, and more particularly to a system for performing underground irrigation of landscaping articles utilizing a customizable modular water delivery system.

### BACKGROUND

The statements in this section merely provide background information related to the present disclosure and may not constitute prior art.

With recent emphasis on green technologies, and the conservation of natural resources, communities across the globe are focusing on alternative ways to reduce water consumption. In the United States alone, irrigation accounts for nearly one third of the overall water consumption, and is currently the largest use of fresh water. For this reason, many states are implementing watering restrictions on the amount of time and/or volume of water that can be utilized for irrigation.

Conventional sprinkler systems for providing water to landscape articles such as grass, plants, trees and the like, typically utilize an above ground sprinkler head configured to spray water across a designated area. However, depending on the force of the water spray, the topographical features of the landscape, and the weather conditions at the time of watering, a significant portion of the sprayed water is often wasted. To this end, the water spray may be deflected by a building, may freeze in cold conditions, or may evaporate in hot conditions before being able to reach the root of the landscape article.

Owing to the above described inefficiencies of traditional irrigation systems, it is necessary to increase the time and volume of water disbursed across the designated area in the hope that an acceptable amount of water will ultimately reach the root. However, due to the watering restrictions imposed by various municipalities, it is becoming more difficult to provide adequate irrigation to landscape articles while remaining within the regulated limits.

Although there have been previous devices directed towards subterranean water delivery, these “drip” irrigation systems have generally consisted of individual runs and have had extremely limited coverage areas and irregular water delivery depending on the length of the run.

Accordingly, there remains a need for a modular subterranean irrigation system capable of providing uniform water delivery directly to the roots of landscape articles within a designated area that does not suffer from the drawbacks of the devices described above.

### SUMMARY OF THE INVENTION

The present invention is directed to a modular subterranean irrigation system for providing water to the roots of landscape articles. One embodiment of the present invention can include one or more water delivery modules constructed from multiple interconnected hollow tubular elements. The tubular elements can each have an elongated body having a plurality of openings for transporting and discharging water to an underground environment.

Another embodiment can further include a water source connector configured to connect the water delivery module to a water source such as a spigot or hose.

Yet another embodiment can further include a water source connector configured to connect the water delivery module to an existing irrigation system.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 illustrates one embodiment of a modular subterranean irrigation system that is useful for understanding the inventive concepts disclosed herein.

FIG. 2 is a top view of a single water delivery module according to one embodiment.

FIG. 3 is a side view of the single water delivery module according to one embodiment.

FIG. 4 is a top view of the single water delivery module in operation, according to one embodiment.

FIG. 5 is a top view of the modular subterranean irrigation system in operation according to another embodiment.

FIG. 6 is a top view of the modular subterranean irrigation system in operation according to an alternate embodiment.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

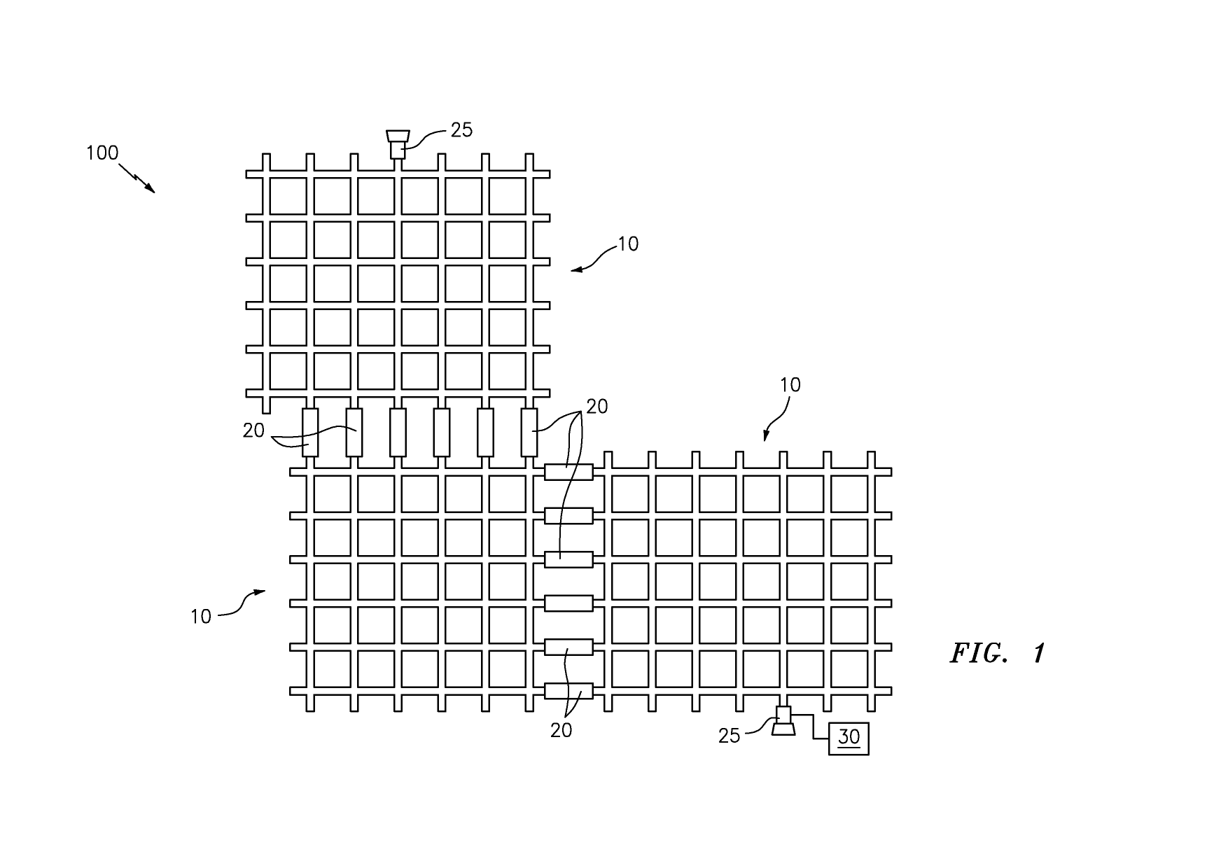

For purposes of this description, the terms “upper,” “bottom,” “right,” “left,” “front,” “vertical,” “horizontal,” and derivatives thereof shall relate to the invention as oriented in FIG. 1.

FIG. 1 illustrates one embodiment of a modular subterranean irrigation system 100 that includes water delivery modules 10, module connectors 20, water source connectors 25 and an optional substance delivery can 30. As will be described below, the system 100 can utilize a series of pre-fabricated modules to provide direct subterranean irrigation to landscape articles in a novel fashion.

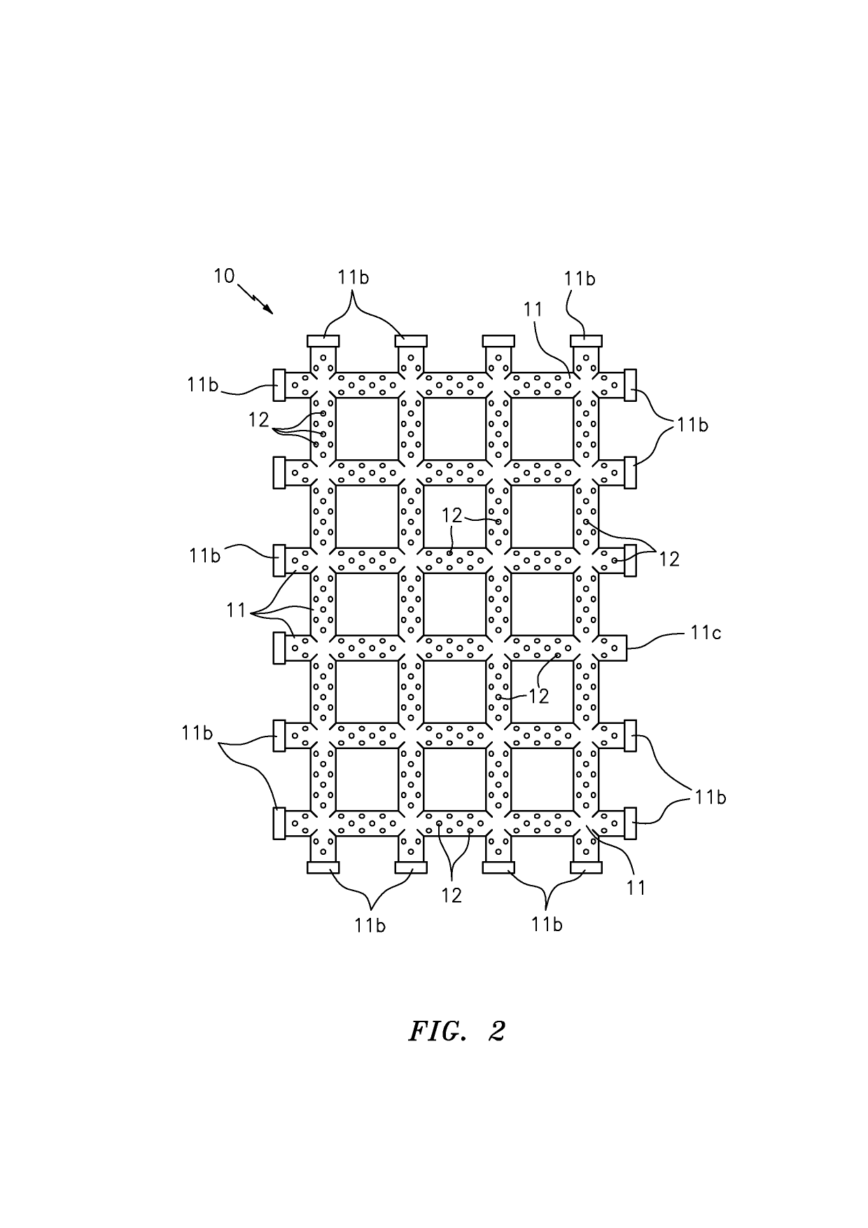

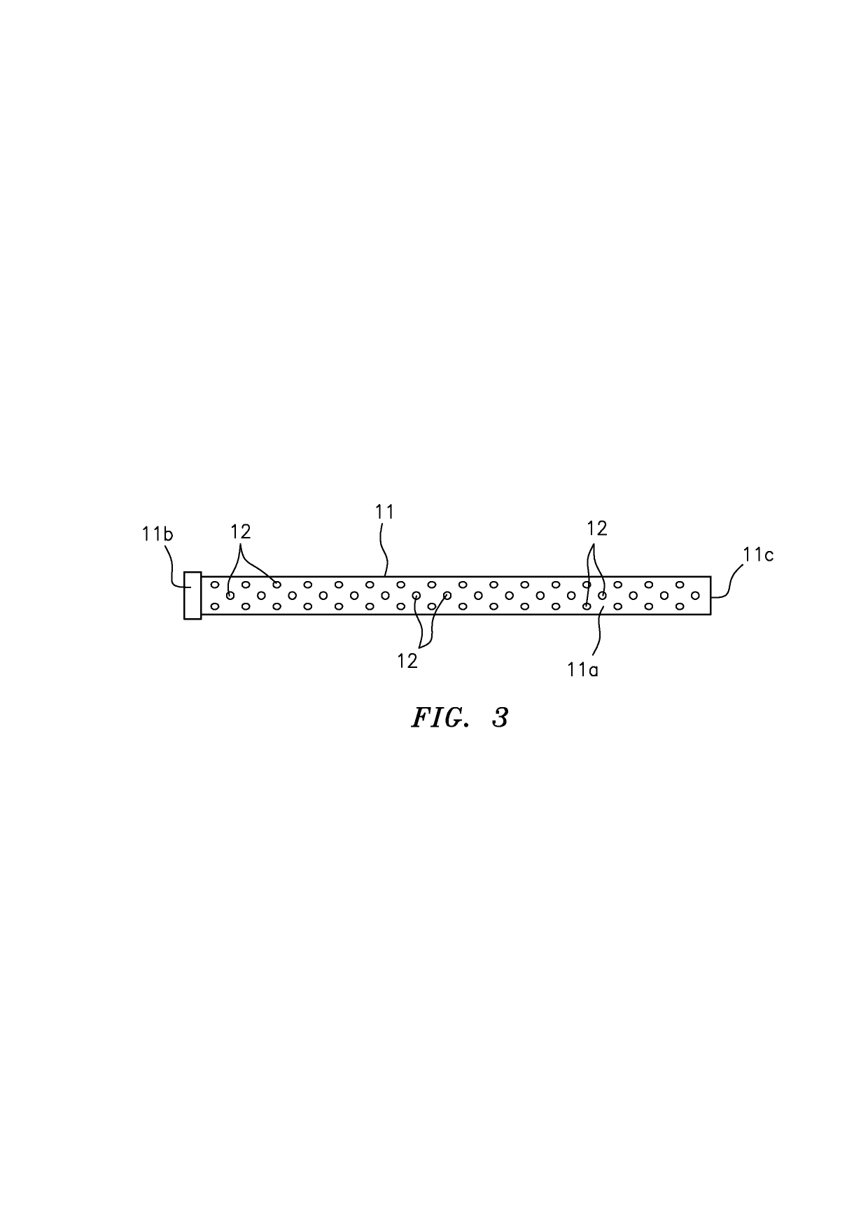

FIGS. 2 and 3 illustrate one embodiment of a water delivery module 10 suitable for use with the system 100 described above. Water delivery modules 10 are configured to be buried beneath and around landscape articles such as grass, plants, bushes, trees and the like. As shown, the water delivery module 10 can comprise a series of hollow tubular elements 11, that are interconnected to form a grid or lattice structure capable of conveying and delivering water in a uniform manner.

As best shown in FIG. 3, each tubular element 11 includes an elongated body having a hollow interior 11a, and a plurality of openings 12 for allowing water contained within the hollow interior to be removed. As shown, each end of each tubular element 11 can include either a capped portion 11b, or an inlet 11c for receiving water.

As described herein, a capped portion 11b can include any number of known barriers for preventing access to the hollow interior of the tubular element, such as a separate internal or external plug, or a barrier molded into the construction of the element 11 itself. Further, an inlet 11c can be defined by the absence of a capped portion, thus resulting in the hollow interior 11a being accessible. Inlets 11c can be created at the time of manufacture or can be created in the field by cutting or otherwise removing the capped portion of any given tubular element. To this end, each module 10 can be manufactured with any number of capped ends and/or inlets.

In one embodiment, each of the modules 10 and tubular elements 11 can be constructed from a durable lightweight material having excellent tensile strength and rust preventive qualities, such as plastic, aluminum or Polyethylene, for example. In one preferred embodiment, each module can be constructed from Tygon® plastic tubing. Moreover, each of the tubular elements 11 can be interconnected into modules 10 utilizing any number of conventional construction methodologies ranging from molds of injected plastic, welding, and/or couplers. In either case, each of the tubular elements 11 will be arranged so as to allow water to flow through the hollow interior sections 11a for removal by the plurality of openings 12.

Although described above as openings 12, one alternate embodiment can include a plurality of one way valves (not illustrated) in addition to, or in place of the plurality of openings 12. Such a feature can act to allow water to be removed from the delivery modules 10 while preventing items such as dirt, debris and organisms from entering the system.

While the dimensions of the elements are not critical, one exemplary module 10 can include an overall length of 9′×6′, and each tubular element 11 can include an outside diameter of ⅜″, an inside diameter of ¼″, and a plurality of openings having a diameter of 0.32″ and spaced at 6″ intervals.

Although each of the modules 10, tubular elements 11 and openings 12 are illustrated as including uniform spacing and sizing, one of skill in the art will recognize that other embodiments can include components of varying sizes and spacing. For example, each module included within the system can include an identical or different dimension. Additionally, each tubular element 11 within the same or different module 10 can include varying dimensions, in order to ensure water flowing through the device maintains a uniform water pressure. As is known to those of skill in the art, the further from the water source a line gets, the smaller the diameter of the line needs to become to maintain adequate pressure. Accordingly, it is to be understood that each module 10 and/or element 11 and opening 12 within the same or different module can include identical or varying dimensions.

A module connector 20 can include any number of known connection devices having a size and material suitable for providing a path for water to pass between the inlets 11c of two tubular elements 11. Suitable examples of module connectors 20 include conventional quick connect coupling fittings and in-line push connect fittings, among many others.

A water source connector 25 can include any number of known connection devices having a size and material suitable for connecting to a water source. For example, water source connector 25 can include a spigot head having threads for receiving a conventional water hose or connecting directly to the spigot of a building. Alternatively, water source connector 25 can include components for attaching to an existing traditional sprinkler head, such as barbed internal to threaded external fittings capable of being mated to a PVC threaded socket connection, or a PVC expander/reducer for connecting to a tee connection in the existing sprinkler feeder line.

Although described above as utilizing specific types of connectors 20 and 25, one of skill in the art will recognize that this is for illustrative purposes only, as any number of other known hardware capable of performing the identified task can be utilized without deviating from the scope and spirit of the inventive concepts disclosed herein.

The substance delivery device 30 act to store and introduce items such as liquid fertilizer, pesticides and other such materials into the system 100. Substance delivery devices are well known in the art and typically include a storage tank containing a solution (such as liquid fertilizer, for example) and a series of valves for mixing fresh water with contents of the tank before releasing the mixture into the system 100. Accordingly, in one preferred embodiment, device 30 will be connected to the water source connector 25 in order to allow the incoming water to mix with the contents of the tank and then transfer the mixed solution into the module 10.

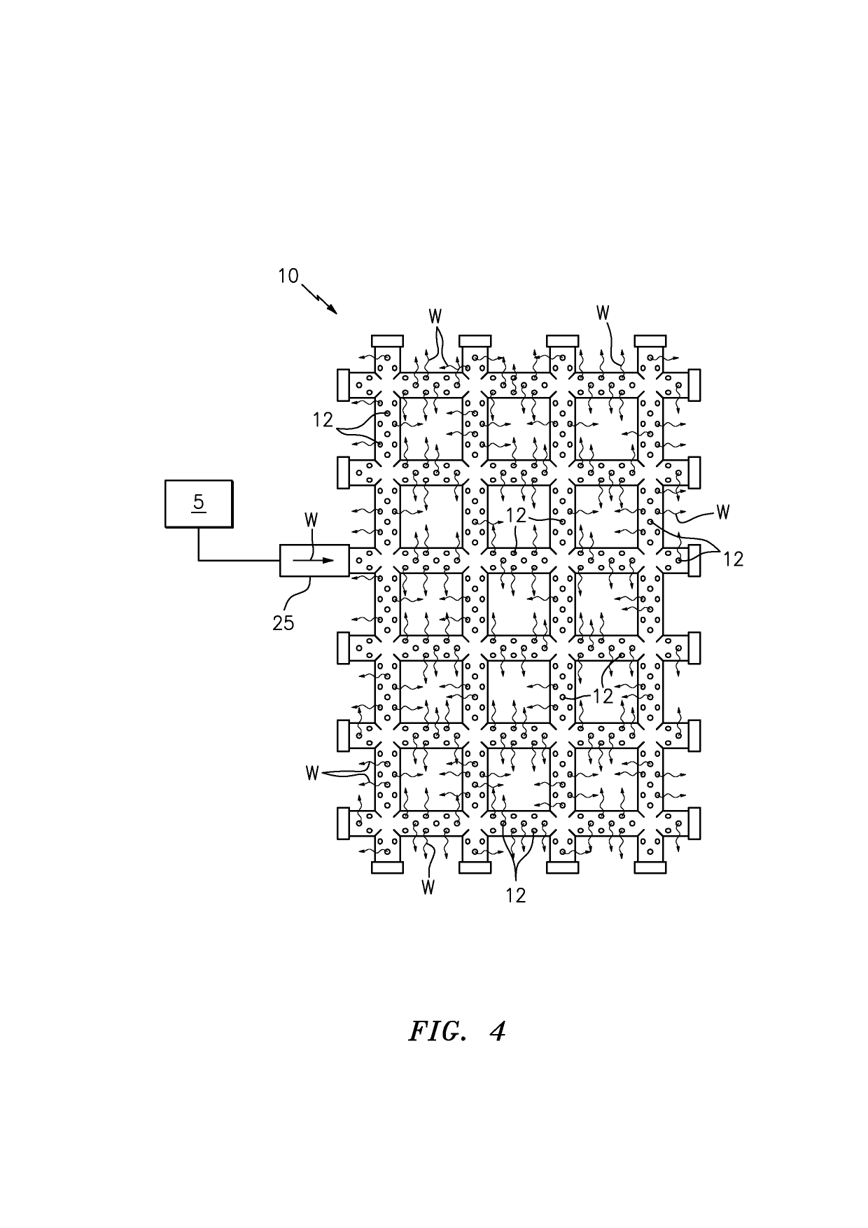

In operation, and as illustrated in FIG. 4, the modular subterranean irrigation system 100 can be utilized to uniformly provide water to landscape articles across a designated area. To this end, one or more delivery modules 10 can be connected to a water source 5 via the source connector 25, and then buried across a designated area. When the water W is turned on, pressure from the source 5 will act to fill each of the channels 11, while releasing measured amounts of water to the surrounding areas via openings 12.

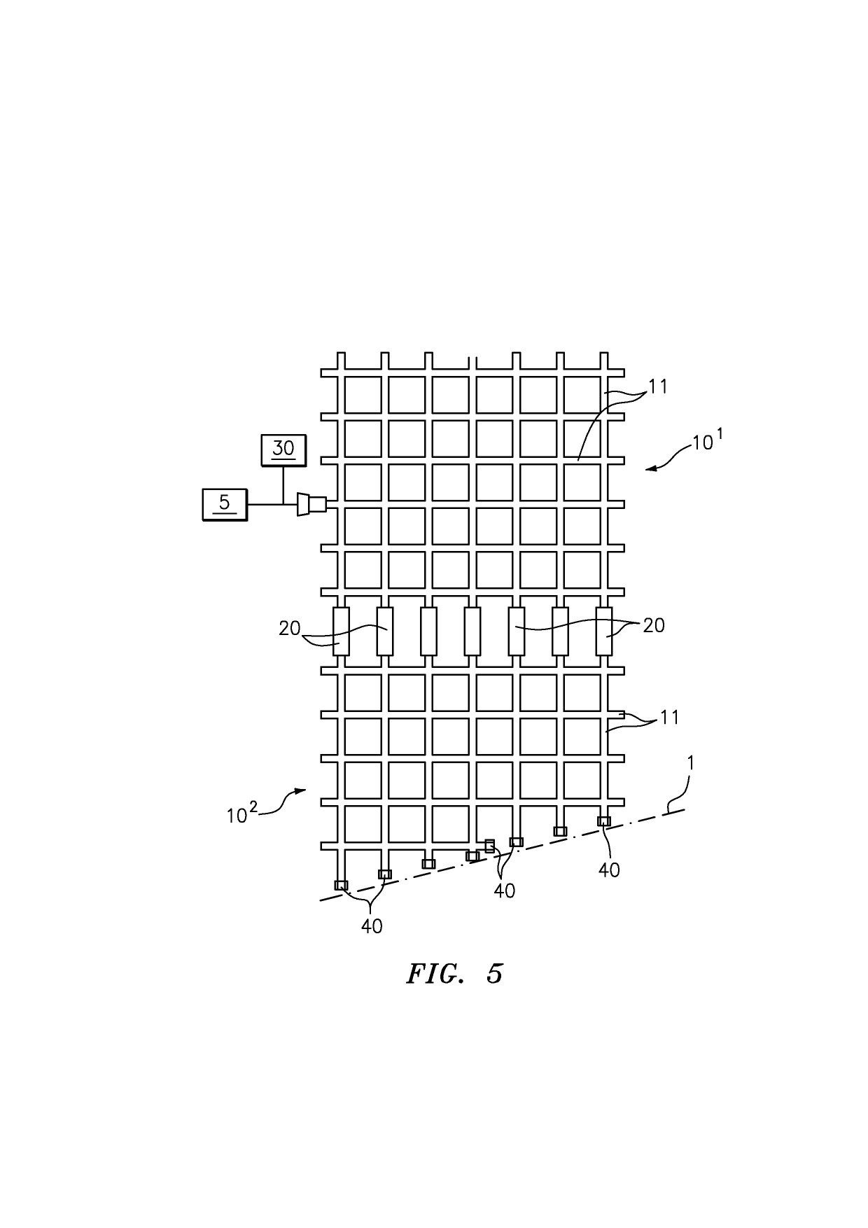

FIG. 5 illustrates the system 100 being installed onto an irregularly shaped area. In this embodiment, first delivery module 10¹ can be connected to a water source 5, such as a well or house spigot. As shown, the two modules 10¹ and 10² can be connected by a plurality of module connectors 20 in order to ensure water from the source 5 flows through the system. Moreover, the bottom section of module 10² can be cut at the time of installation to match the irregular boundary line 1, and each of the cut elements 11 can be capped in the field by standard plastic tube caps or plugs 40.

Although described above as utilizing tube caps, one alternate method could involve a tube sealer tool, where the ends are compressed while being heated. The details of these cuts can be determined, pre-configured and implemented by computer at locations remote to the irrigation objective, such as the assembly factory, or at the time of installation at the irrigation objective location.

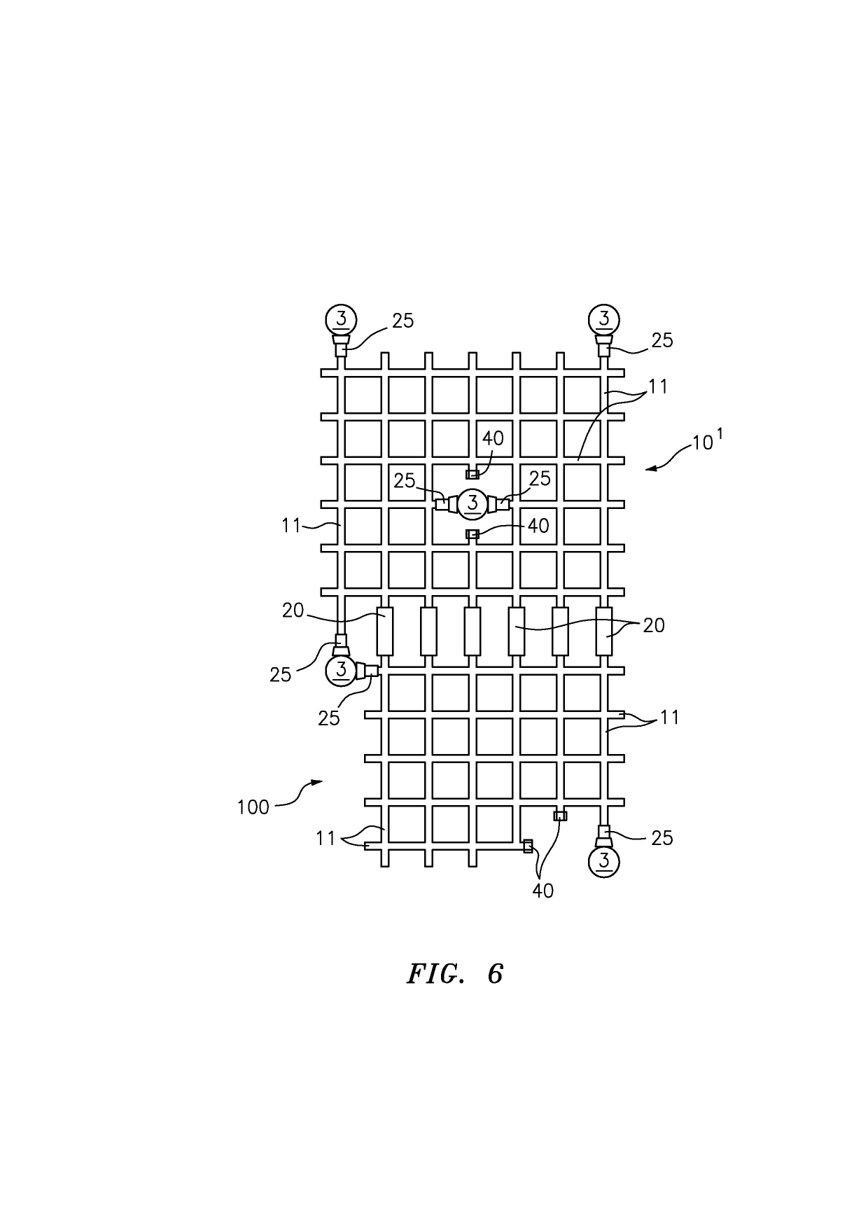

As previously stated, the modular subterranean irrigation system 100 can be utilized in conjunction with existing irrigation systems. As shown in FIG. 6, the system can be installed into the designated area, and connected to a plurality of pre-existing sprinkler heads 3 via the water source connectors 25. To this end, it is possible to utilize the pre-existing water supply lines and/or sprinkler timers to provide water for the system 100.

As described herein, one or more elements of the modular subterranean irrigation system 100 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individual elements such as each individual water delivery module 10, the plurality of tubular elements 11, module connectors 20, inlet connectors 25 and/or caps 11b and 40, for example, may be formed together as one continuous element, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A modular subterranean irrigation system for providing water to the roots of landscape articles, said system comprising:
a plurality of water delivery modules, each of said modules consisting of a plurality of interconnected hollow tubular elements configured to receive and transport water, each of said tubular elements including an elongated body and a pair of opposing ends having one of a capped portion and an inlet;
at least one water source connector that is secured to at least one of the water delivery modules, and configured to receive water from a water source;
at least one tubular element of a single water delivery module including a size and dimension that is not the same as another tubular element of the same water delivery module, said dimension including a line diameter that is based on a distance from the water source connector, and configured to regulate a water pressure within the system,
wherein the line diameter at a location close to the water source is greater than the line diameter at a location distant from the water source; and
a plurality of openings disposed on each of the plurality of water delivery modules, said openings being configured to directly discharge the water into an outside environment,
wherein at least one of the plurality of openings on each of the plurality of water delivery modules includes a different dimension than another opening on the same water delivery module.

2. The modular subterranean irrigation system of claim 1, wherein each of said water delivery modules are configured to be buried.

3. The modular subterranean irrigation system of claim 1, further comprising:
a plurality of module connectors configured to allow water to flow between two different water delivery modules.

4. The modular subterranean irrigation system of claim 3, wherein said module connectors include at least one of a quick connect coupling fitting and an in-line push connector.

5. The modular subterranean irrigation system of claim 1, wherein said water source connector is configured to connect to at least one of a building spigot and a water hose.

6. The modular subterranean irrigation system of claim 1, wherein said water source connector is configured to connect to an existing irrigation sprinkler head.

7. The modular subterranean irrigation system of claim 1, further comprising:
a substance delivery device configured to store a liquid substance, mix the liquid substance with water supplied by the water source, and introduce the mixed liquid substance into the water delivery module.

8. The modular subterranean irrigation system of claim 1, wherein each of said tubular elements are connected to form a lattice structure.

9. (canceled)

10. The modular subterranean irrigation system of claim 1, wherein each of said water delivery modules are constructed from a singular piece of pre-fabricated material.

11. The modular subterranean irrigation system of claim 1, wherein each of said water delivery modules are constructed from at least one of plastic, aluminum and polyethylene.

12. The modular subterranean irrigation system of claim 1, further comprising:
a plurality of one way valves that are in communication with each of the plurality of openings, said valves being configured to allow the water to discharge, and to prevent foreign objects from entering the system.

13. The modular subterranean irrigation system of claim 1, wherein each of the tubular elements of at least one of the plurality of water delivery modules includes an identical size, dimension and diameter.

14-16. (canceled)

17. The modular subterranean irrigation system of claim 1, wherein each water delivery module is constructed having a size and dimension corresponding to at least one of an intended use and distance from water source.

18. (canceled)

19. The modular subterranean irrigation system of claim 1, further comprising:
a plurality of water source connectors each configured to connect to a different water source.

20. The modular subterranean irrigation system of claim 19, wherein at least two of the plurality of water source connectors are secured to the same water delivery module.

21. The modular subterranean irrigation system of claim 19, wherein at least two of the plurality of water source connectors are secured to different water delivery modules.

22. The modular subterranean irrigation system of claim 19, wherein at least one of the plurality of water source connectors is configured to connect to an existing irrigation sprinkler head, and another of the water source connectors is configured to connect to a building spigot.
